(19) United States
(12) Patent Application Publication
(10) Pub. No.: US 2025/0094181 A1
(43) Pub. Date: Mar. 20, 2025

(54) DESIRED STATE MANAGEMENT OF HOSTS AND CLUSTERS IN A HYBRID CLOUD

(71) Applicant: VMware LLC, Palo Alto, CA (US)

(72) Inventors: Nidhin URMESE, Bangalore (IN); Lakshmikanth RAJU, Bangalore (IN); Prithvi KAMATH, Bangalore (IN); Narasimha Gopal GORTHI, Bangalore (IN); Mayur BHOSLE, San Jose, CA (US)

(21) Appl. No.: 18/607,301

(22) Filed: Mar. 15, 2024

(30) Foreign Application Priority Data
Sep. 19, 2023 (IN) 202341062863

(51) Int. Cl. G06F 9/445

(52) U.S. Cl. CPC G06F 9/44505

(57) ABSTRACT

A method of managing desired states for host computers and for clusters of host computers of software-defined data centers (SDDCs), includes the steps of: creating a first desired state file for a first cluster of the clusters and creating a second desired state file for a second cluster of the clusters, and storing the first and second desired state files together, wherein the first and second clusters are in a first SDDC of the SDDCs, and wherein the second desired state file includes desired configurations that are absent from the first desired state file; and transmitting a first instruction to update actual configurations of the first cluster to match corresponding desired configurations from the first desired state file and transmitting a second instruction to update actual configurations of the second cluster to match corresponding desired configurations from the second desired state file.

### CROSS-REFERENCE

This application is based upon and claims the benefit of priority from Indian Patent Application No. 202341062863 filed on Sep. 19, 2023, the entire contents of which are incorporated herein by reference.

### BACKGROUND

In a software-defined data center (SDDC), virtual infrastructure (VI), which includes virtual machines (VMs) and virtualized storage and networking resources, is provisioned from hardware infrastructure. The hardware infrastructure includes a plurality of host computers, referred to herein simply as “hosts,” and includes storage and networking devices. The provisioning of the VI is carried out by SDDC management software that is deployed on management appliances such as a VMware vCenter Server® appliance and a VMware NSX® appliance, available from VMware, Inc. The SDDC management software manages the VI by communicating with virtualization software (e.g., hypervisors) installed in the hosts.

It has become common to deploy multiple SDDCs across multiple clusters of hosts. Each cluster is a group of hosts that are managed together by SDDC management software to provide cluster-level functions. For example, the functions include load balancing across the cluster through VM migration between hosts, distributed power management, dynamic VM placement according to affinity and anti-affinity rules, and high availability (HA). The SDDC management software also manages shared storage devices from which storage resources for the clusters are provisioned. The SDDC management software also manages software-defined networks through which the VMs communicate.

Today, many organizations have SDDCs deployed across different geographical regions and even in a hybrid manner. A hybrid cloud includes applications running in a combination of different environments, e.g., on-premise, in a private cloud, in a public cloud, and as a service. SDDCs that are deployed on-premise are provisioned in a particular organization's own information technology (IT) environment. SDDCs that are deployed in a private cloud are provisioned in a private data center controlled by the organization. SDDCs that are deployed in a public cloud are provisioned in a public data center at which SDDCs of other organizations are also provisioned. SDDCs that are deployed as a service are provided to the organization on a subscription basis such that management operations such as configuring, upgrading, and patching are performed for the organization according to a service-level agreement (SLA).

With increasing numbers of SDDCs, monitoring and performing operations on SDDCs and managing the lifecycle of management software therein have proven to be challenging. Conventional techniques include defining the desired state of each SDDC in a declarative document (file), the desired state including desired configurations for services running in management appliances of the SDDC. The SDDCs are deployed and periodically updated according to desired states defined in respective desired state files. However, in many cases, such techniques are inflexible for users who want to manage and configure SDDCs at varying levels of granularity. A method is desired for managing desired states of SDDCs at such varying levels in a manner that is practicable in a hybrid cloud environment.

### SUMMARY

One or more embodiments provide a method of managing desired states for hosts and for clusters of hosts of SDDCs. The method includes the steps of: creating a first desired state file for a first cluster of the clusters and creating a second desired state file for a second cluster of the clusters, and storing the first and second desired state files together, wherein the first and second clusters are in a first SDDC of the SDDCs, and wherein the second desired state file includes desired configurations that are absent from the first desired state file; and transmitting a first instruction to update actual configurations of the first cluster to match corresponding desired configurations from the first desired state file and transmitting a second instruction to update actual configurations of the second cluster to match corresponding desired configurations from the second desired state file.

Further embodiments include a non-transitory computer-readable storage medium comprising instructions that cause a host to carry out the above method, as well as a host configured to carry out the above method.

### BRIEF DESCRIPTION OF THE DRAWINGS

FIG. 1 is a block diagram of customer environments of different organizations that are managed through a multi-tenant cloud platform implemented in a public cloud.

FIG. 2 is a block diagram of the public cloud and an SDDC of one of the customer environments, according to embodiments.

FIG. 3 is a block diagram of services of a VM management appliance of the SDDC, according to embodiments.

FIGS. 4A-4D are block diagrams illustrating examples of user interfaces (UIs) for creating, assigning, and managing desired state files, according to embodiments.

FIG. 5 is a flow diagram of a method performed by a configuration service of the public cloud to create and apply a desired state file to one or more clusters or one or more standalone hosts, according to embodiments.

FIG. 6 is a flow diagram of a method performed by the configuration service to update and apply a desired state file in response to drift with actual configurations of a cluster or of a standalone host, according to embodiments.

### DETAILED DESCRIPTION

Techniques are described for managing desired state files (also referred to herein as “profiles”) of clusters and hosts of SDDCs. According to embodiments, a cloud platform delivers various services to the SDDCs through agents that are running in an appliance. The services of the cloud platform are referred to herein as “cloud services,” and the appliance in which the agents are running is referred to as an “agent platform (AP) appliance.” The cloud platform is provisioned in a public cloud, and the AP appliance is deployed in a customer environment along with management appliances.

Each of the cloud services has a corresponding agent on the AP appliance that the cloud service communicates with, the cloud platform and AP appliance being connected over a public network such as the Internet. Furthermore, the AP appliance and management appliances are connected to each other over a private network of the customer environment such as a local area network (LAN). Accordingly, the cloud services and management appliances are able to communicate through the agents of the AP appliance. Through such communication, a cloud service referred to herein as a “configuration service” manages the desired states of SDDCs.

Via a UI of the cloud platform, a user of an organization creates desired state files and assigns them at various levels of granularity. As a first example, the user assigns a desired state file to one or more clusters of hosts. As a second example, the user assigns a desired state file to one or more hosts that are not being managed in clusters, such hosts referred to herein as “standalone hosts.” In both examples, the user manages configurations at lower levels of granularity than at the SDDC level.

For example, if there are multiple clusters that the user wishes to configure similarly, the user creates and applies a desired state file for just those clusters, regardless of whether those clusters are in the same or different SDDCs. The cloud platform instructs management software in each relevant SDDC to update configurations of the selected clusters accordingly. Similarly, if there are multiple standalone hosts that the user wishes to configure similarly, the user creates and applies a desired state file for just those hosts, regardless of whether those hosts are in the same or different SDDCs. These and further aspects of the invention are discussed below with respect to the drawings.

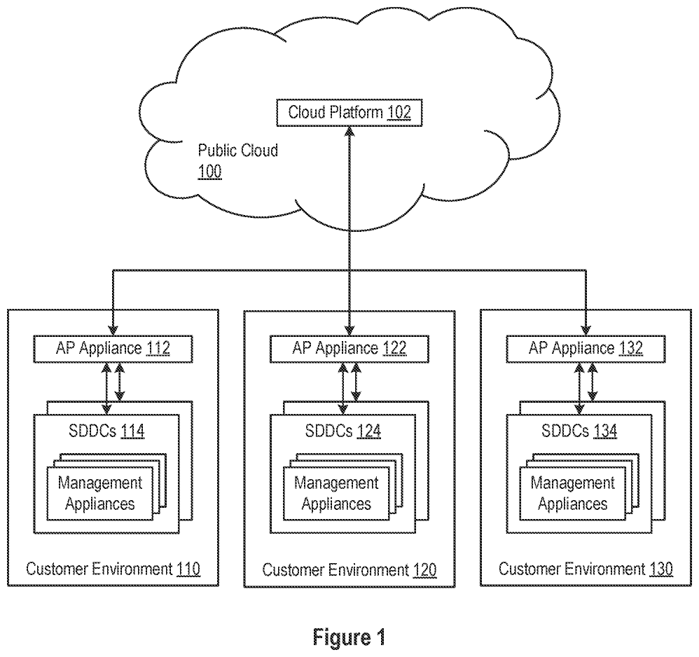

FIG. 1 is a block diagram of customer environments of different organizations (customers). The customer environments are managed through a multi-tenant cloud platform 102 implemented in a public cloud 100. A plurality of SDDCs is illustrated in each of the customer environments, including SDDCs 114 in a customer environment 110, SDDCs 124 in a customer environment 120, and SDDCs 134 in a customer environment 130. As used herein, a “customer environment” is a hybrid cloud.

In each customer environment, the SDDCs are managed by respective management appliances. The management appliances of each of the customer environments include a VM management appliance (e.g., a VMware vCenter Server® appliance, available from VMware, Inc.) for overall management of VI. The management appliances of each of the customer environments further include a network management appliance (e.g., a VMware NSX® appliance, available from VMware, Inc.) for management of software-defined networks.

The management appliances in each of the customer environments communicate with a respective AP appliance, including an AP appliance 112 in customer environment 110, an AP appliance 122 in customer environment 120, and an AP appliance 132 in customer environment 130. Agents (not shown in FIG. 1) are installed on each of the AP appliances, and the agents communicate with cloud platform 102 to deliver cloud services to respective customer environments. In some embodiments, each of the AP appliances and each of the management appliances are a VM instantiated on a host. In other embodiments, any of the AP appliances and the management appliances are implemented as hosts.

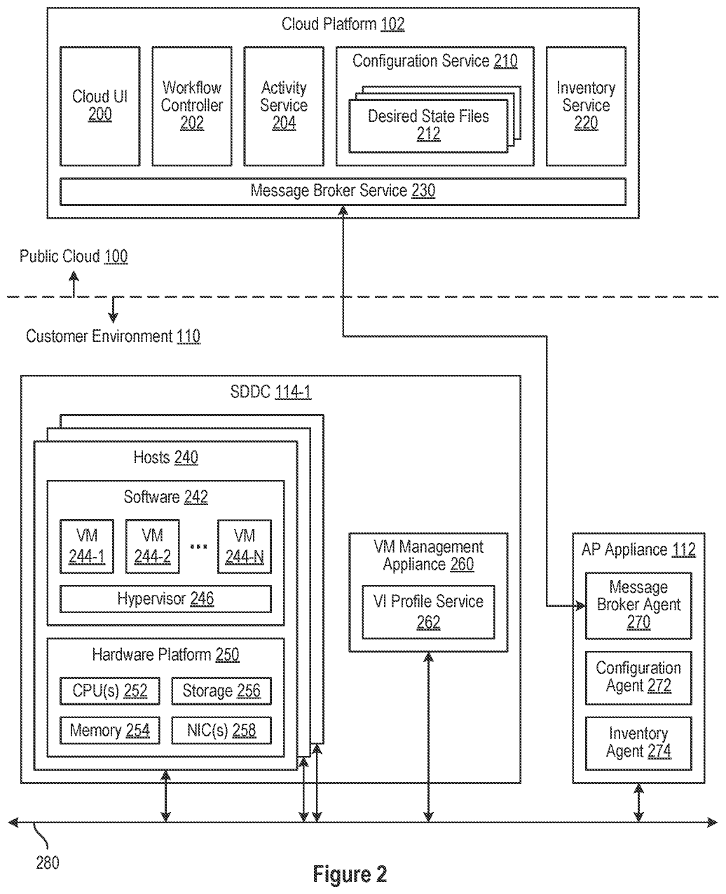

FIG. 2 is a block diagram of public cloud 100 and an SDDC 114-1 of customer environment 110, according to embodiments. SDDC 114-1 includes a plurality of hosts 240 and a VM management appliance 260. Each of hosts 240 is constructed on a hardware platform 250 such as an x86 architecture platform. Hardware platform 250 includes conventional components of a computing device, such as one or more central processing units (CPUs) 252, memory 254 such as random-access memory (RAM), storage 256 such as one or more magnetic drives or solid-state drives (SSDs) and/or a host bus adapter for connecting to a storage area network, and one or more network interface cards (NICs) 258. NIC(s) 258 enable hosts 240 to communicate with each other and with other devices over a network 280.

Network 280 is distinguishable from a public network such as the Internet through which cloud platform 102 communicates with devices of customer environment 110. Network 280 is a private network, e.g., a LAN or a sub-net, and is partitioned from the public network through a firewall. Hardware platform 250 of each of hosts 240 supports software 242. Software 242 includes a hypervisor 246, which is a virtualization software layer. Hypervisor 246 supports a VM execution space within which VMs 244 are concurrently instantiated and executed. One example of hypervisor 246 is a VMware ESX® hypervisor, available from VMware, Inc.

According to embodiments, VM management appliance 260 logically groups some of hosts 240 into one or more clusters to perform cluster-level tasks such as provisioning and managing VMs 244 and migrating VMs 244 from one of hosts 240 to another. VM management appliance 260 also manages some of hosts 240 as standalone hosts that are not in any such clusters. VM management appliance 260 communicates with hosts 240 via a management logical network (not shown) provisioned from network 280. For example, VM management appliance 260 may be one of VMs 244.

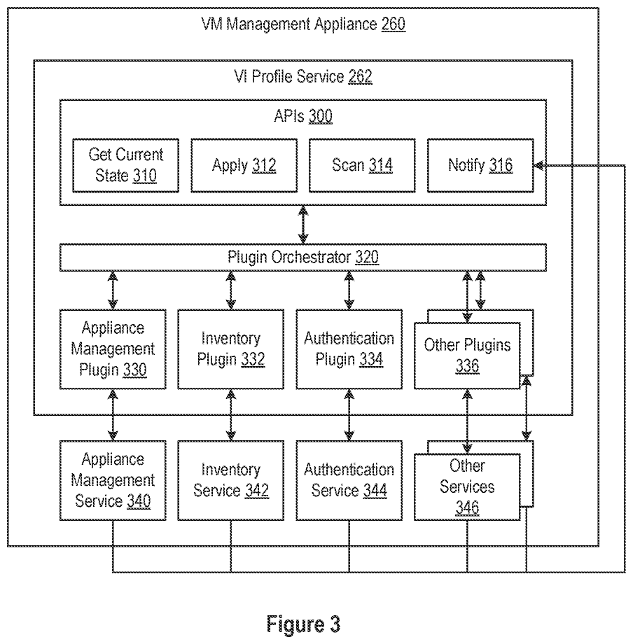

VM management appliance 260 includes a VI profile service 262 and various other services (not shown in FIG. 2). VI profile service 262 provides various functionalities for managing clusters and standalone hosts of SDDC 114-1 such as getting current states of clusters and standalone hosts and applying desired state files thereto. VM management appliance 260 issues role-based authentication tokens to agents of AP appliance 112, each authentication token allowing an agent possessing the token to access VM management appliance 260 to perform operations that are associated with the issued token. VM management appliance 260 is discussed further below in conjunction with FIG. 3.

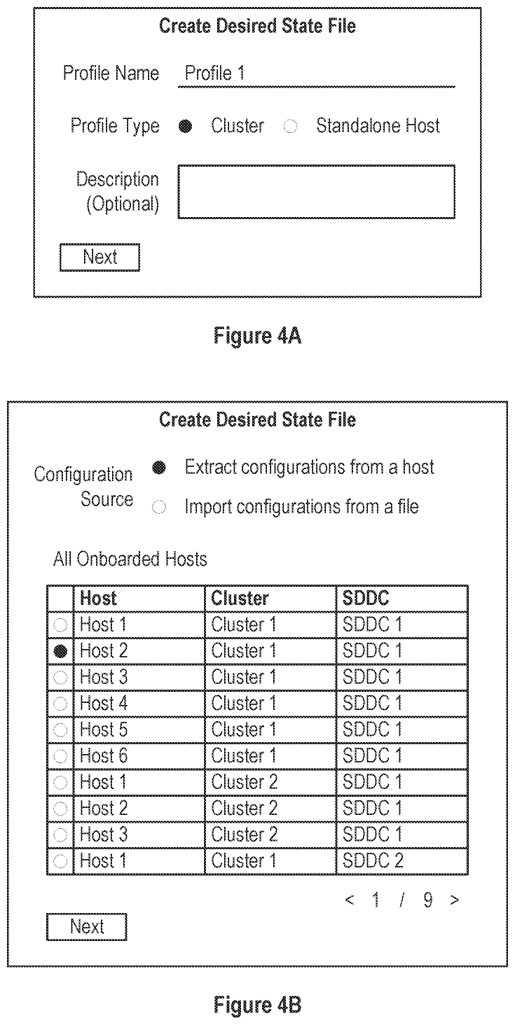

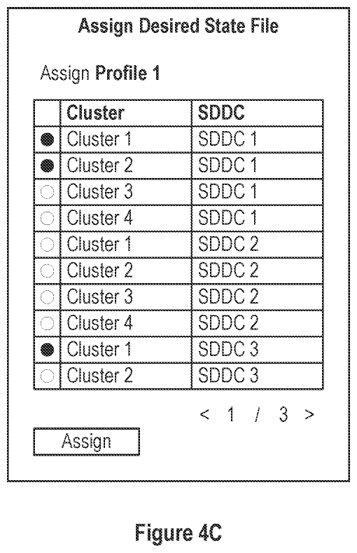

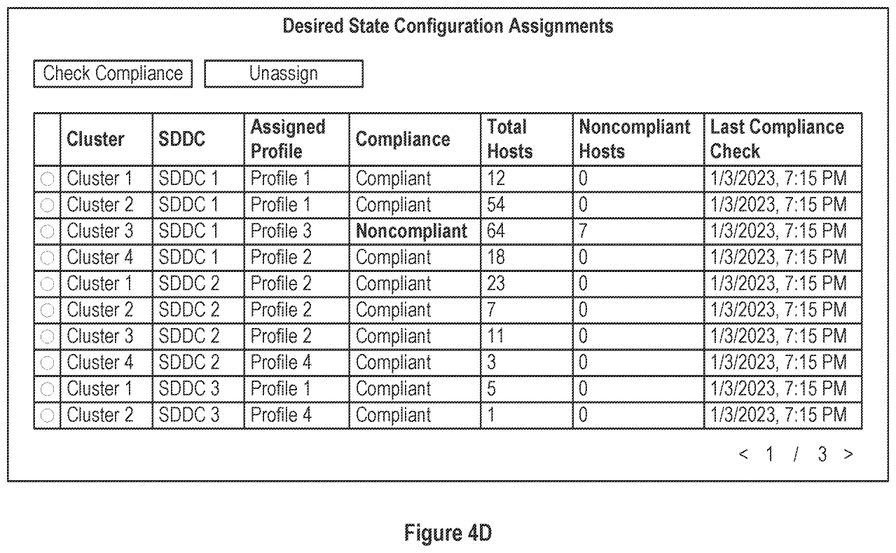

Public cloud 100 is operated by a cloud computing service provider from a plurality of hosts (not shown). CPU(s) of the hosts are configured to execute instructions such as executable instructions that perform one or more operations described herein, which may be stored in memory of the hosts. Cloud platform 102 includes a cloud UI 200, a workflow controller 202, and various cloud services. The organization that uses customer environment 110 accesses cloud platform 102 via cloud UI 200 to create desired state files, assign desired state files to clusters and standalone hosts, etc. Cloud UI 200 is discussed further below in conjunction with FIGS. 4A-4D.

The cloud services of cloud platform 102 include an activity service 204, a configuration service 210, an inventory service 220, and a message broker service 230. Activity service 204 stores instructions to perform activities such as detecting drift between actual configurations of clusters and standalone hosts and desired state files assigned thereto. Workflow controller 202 communicates with activity service 204 to retrieve such instructions and then transmits messages to message broker service 230 to be further transmitted to AP appliance 112, as discussed further below. The messages include instructions for agents of AP appliance 112 to perform the activities.

Configuration service 210 manages desired states of clusters and standalone hosts for the organization. Configuration service 210 stores desired state files 212, which are collections of configurations assigned to the clusters and standalone hosts. Configuration service 210 creates activities for activity service 204 in response to user requests, e.g., to detect drift. Inventory service 220 manages inventory items for the organization such as clusters and standalone hosts. Cloud platform 102 also includes other services such as a cloud authentication service that issues access tokens for agents of AP appliance 112 to authenticate with the cloud services of cloud platform 102. For example, each of the cloud services of cloud platform 102 may be a microservice implemented as one or more container images of public cloud 100.

AP appliance 112 includes agents such as a message broker agent 270, a configuration agent 272, and an inventory agent 274. Message broker agent 270 communicates with message broker service 230 to establish communication between cloud platform 102 and AP appliance 112. Agents of AP appliance 112 provide messages to message broker agent 270, and cloud services of cloud platform 102 provide messages to message broker service 230. Message broker service 230 and message broker agent 270 periodically exchange messages. Message broker service 230 then distributes messages from AP appliance 112 to cloud services, and message broker agent 270 distributes messages from cloud platform 102 to agents.

Configuration agent 272 communicates with configuration service 210, e.g., to download desired state files 212 to be applied to clusters and standalone hosts. Inventory agent 274 communicates with inventory service 220, e.g., to provide updated information about the organization's inventory such as the organization deleting a cluster or standalone host of SDDC 114-1. AP appliance 112 also includes other agents (not shown). For example, an identity agent acquires access tokens from cloud platform 102, which other agents of AP appliance 112 use to authenticate with respective cloud services of cloud platform 102. Discovery agents manage communications with management appliances of SDDCs by providing tokens to other agents of AP appliance 112 for authenticating with the management appliances. A coordinator agent installs all the agents of AP appliance 112 and manages the lifecycles thereof. For example, AP appliance 112 may be a VM of customer environment 110.

FIG. 3 is a block diagram of services of VM management appliance 260, according to embodiments. In addition to VI profile service 262, VM management appliance 260 includes an appliance management service 340, an inventory service 342, an authentication service 344, and various other services 346. Appliance management service 340 provides system-level functionalities for VM management appliance 260 such as secure shell (SSH) and network time protocol (NTP). Inventory service 342 creates and manages inventory items in response to instructions from inventory service 220 of cloud platform 102. Authentication service 344 manages role-based access to VMs 244.

Services 340-346 have corresponding plugins to VI profile service 262. The plugins include an appliance management plugin 330, an inventory plugin 332, an authentication plugin 334, and various other plugins 336. VI profile service 262 manages actual configurations of services 340-346 based on desired states files for clusters and standalone hosts. The desired state files include desired configurations to be added to the services, desired configurations being made up of attributes and associated values.

VI profile service 262 exposes various APIs that are invoked by configuration agent 272 and by services 340-346. The APIs include a get-current-state API 310, an apply API 312, a scan API 314, and a notify API 316. Get current state 310 is invoked by configuration agent 272 to obtain the current state (actual configurations) of clusters or standalone hosts. Apply 312 is invoked by configuration agent 272 to update the actual configurations to match desired configurations. Scan 314 is invoked by configuration agent 272 to compute drift in the current states of clusters and standalone hosts from desired configurations. Notify 316 is invoked by services 340-346 to alert VI profile service 262 of changes to actual configurations.

VI profile service 262 includes a plugin orchestrator 320 through which configuration agent 272 communicates with plugins 330-336 via APIs 300. Configuration agent 272 communicates with plugin orchestrator 320, e.g., to obtain via get current state 310, the current states of clusters and standalone hosts. Plugin orchestrator 320 then communicates with plugins 330-336 to obtain respective portions of the current states. Similarly, configuration agent 272 communicates with plugin orchestrator 320 to apply via apply 312, desired state files, and plugin orchestrator 320 communicates respective portions of the desired states to plugins 330-336 for application.

To configure settings such as enabling or disabling SSH, plugin orchestrator 320 provides desired configurations to appliance management plugin 330 to be applied to appliance management service 340. To configure inventories, plugin orchestrator 320 provides desired configurations to inventory plugin 332 to be applied to inventory service 342. To configure authentication privileges, plugin orchestrator 320 provides desired configurations to authentication plugin 334 to be applied to authentication service 344. For desired configurations related to other services 346, plugin orchestrator 320 provides desired configurations to one of other plugins 336 to be applied to other services 346.

FIGS. 4A-4D are block diagrams illustrating examples of UIs of cloud UI 200 for creating, assigning, and managing desired state files, according to embodiments. FIG. 4A is a block diagram of a UI for a first step of creating a desired state file. In a “Profile Name” section, a user of the organization specifies the name “Profile 1” for the desired state file. In a “Profile Type” section, the user specifies that the desired state file is to be created for clusters. There is an optional description section for additional information, and when the user clicks “Next,” configuration service 210 displays the UI of FIG. 4B to the user via cloud UI 200.

FIG. 4B is a block diagram of a UI for a second step of creating a desired state file. In a “Configuration Source” section, cloud UI 200 presents the user with various options of where to obtain configurations for the desired state file. A first option, which the user has selected, is to extract configurations from a host of one of the user's SDDCs that has already been configured or that at least has default configurations to extract. A second option is to import the configurations from a file such as a JavaScript Object Notation (JSON) file, which the user has manually created to include various desired configurations.

Beneath the “Configuration Source” section, because the user selected to “Extract configurations from a host,” cloud UI 200 presents the user with an “All Onboarded Hosts” section. In this section, cloud UI 200 displays a list of hosts to select from along with information about which clusters and which SDDCs the hosts are in. The user has selected a host named “Host 2,” which is in a cluster named “Cluster 1” of an SDDC named “SDDC 1.” When the user clicks “Next,” configuration service 210 extracts actual configurations from the selected host for addition to the desired state profile. For example, in the case of SDDC114-1 of customer environment 110, configuration agent 272 acquires those actual configurations from VM management appliance 260 and then transmits them to configuration service 210. Configuration service 210 then displays the UI of FIG. 4C to the user.

FIG. 4C is a block diagram of a UI for assigning a desired state profile to a plurality of clusters. As illustrated, cloud UI 200 displays a list of clusters to select from along with corresponding SDDCs. The user has selected to assign the desired state file “Profile 1” to three clusters: a cluster named “Cluster 1” in an SDDC named “SDDC1,” a cluster named “Cluster 2” in SDDC1, and a cluster named “Cluster 1” in an SDDC named “SDDC 3.” When the user clicks “Assign,” configuration service 210 assigns Profile 1 to each of the selected clusters. It should be noted that for a desired state file being created for standalone hosts, cloud UI 200 displays a list of hosts to select from along with corresponding SDDCs. A user then selects one or more standalone hosts in the same or in separate SDDCs for assigning the desired state file to.

FIG. 4D is a block diagram of a UI for managing desired state files. As illustrated, cloud UI 200 displays a list of clusters to select from along with information thereof. Such information includes: (1) corresponding SDDCs, (2) desired state files (profiles) assigned thereto, (3) whether or not the clusters are compliant with the assigned desired state files, (4) how many hosts there are in the clusters, (5) how many of the hosts are noncompliant, and (6) the last time compliance was checked.

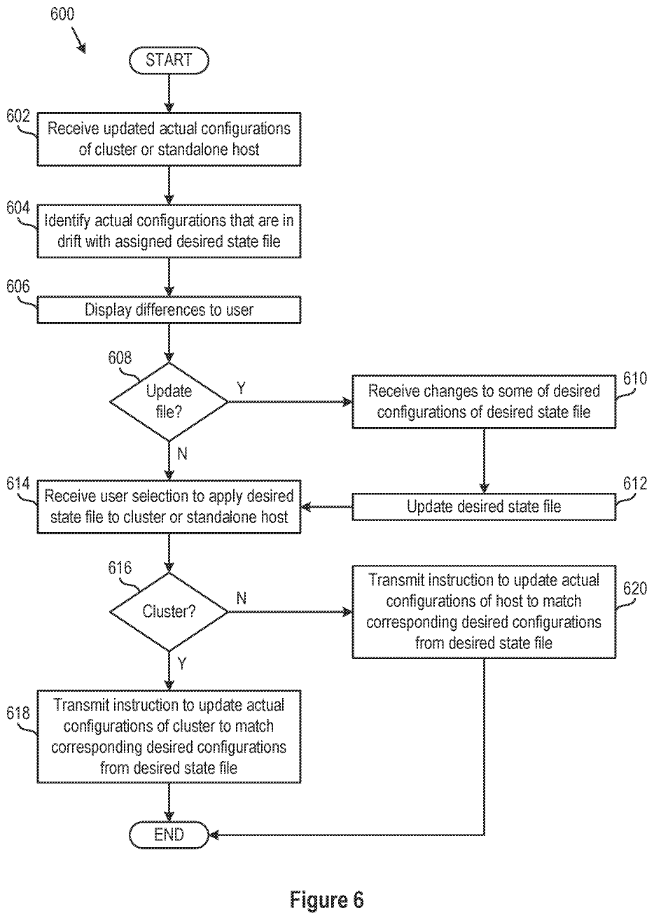

As illustrated, cloud UI 200 also displays options to “Check Compliance” and to “Unassign.” If the user selects a cluster and selects to check the compliance thereof, configuration service 210 compares actual configurations of the cluster to desired configurations of the corresponding desired state file. Any differences are then presented to the user, and the user decides how to proceed, as discussed further below in conjunction with FIG. 6.

If the user selects a cluster and selects to unassign, configuration service 210 unassigns from the cluster the currently-assigned desired state file. The user then creates or selects a new desired state file to assign to the cluster. It should be noted that for a customer environment that includes various standalone hosts, UI 200 similarly displays information about the standalone hosts such as which desired state files are assigned thereto and whether the standalone hosts are compliant with those desired state files. The user also similarly selects to check the compliance for standalone hosts and to unassign desired state files therefrom.

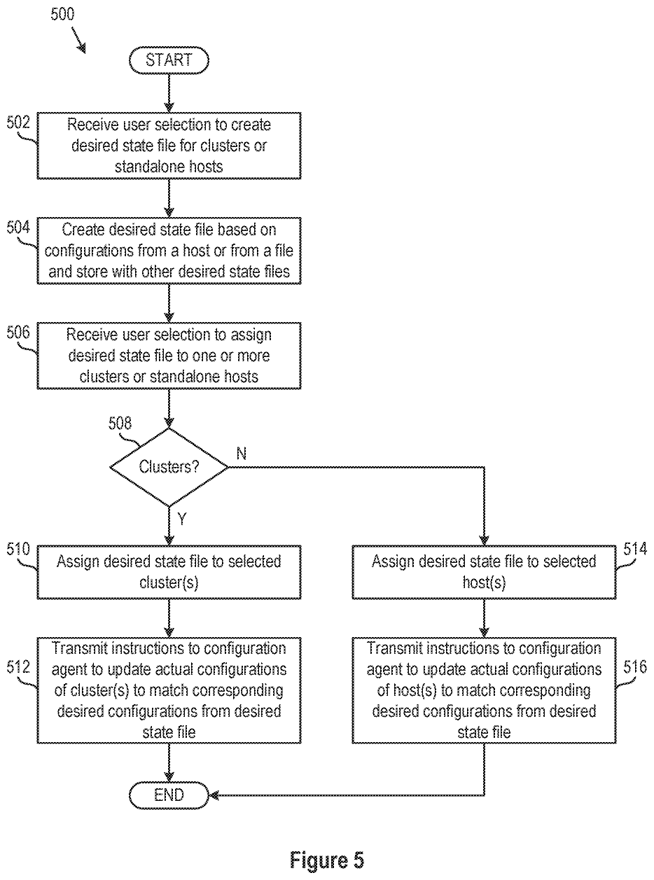

FIG. 5 is a flow diagram of a method 500 performed by configuration service 210 to create and apply a desired state file to one or more clusters or one or more standalone hosts, according to embodiments. At step 502, configuration service 210 receives a user selection to create a desired state file for either clusters or standalone hosts. The user makes the selection via cloud UI 200, as discussed above in conjunction with FIG. 4A. At step 504, configuration service 210 creates the desired state file based on configurations from a host or from a file such as a JSON file. Configuration service 210 persists the desired state file along with other previously created desired state files in storage of the hosts of public cloud 100. As discussed above in conjunction with FIG. 4B, the user identifies via cloud UI 200 where to acquire configurations from for the desired state file.

At step 506, configuration service 210 receives a user selection to assign the desired state file to either one or more clusters or to one or more standalone hosts. The user makes the selection via cloud UI 200, as discussed above in conjunction with FIG. 4C. At step 508, if the user has selected to assign the desired state file to one or more clusters, method 500 moves to step 510. At step 510, configuration service 210 assigns the desired state file to the selected cluster(s). Specifically, configuration service 210 stores metadata indicating that the desired state file is assigned to the selected cluster(s). At step 512, configuration service 210 transmits instructions to configuration agent 272 to update actual configurations of the selected cluster(s) to match corresponding desired configurations from the desired state file. After step 512, method 500 ends.

Returning to step 508, if the user has selected to assign the desired state file to one or more standalone hosts, method 500 moves to step 514. At step 514, configuration service 210 assigns the desired state file to the selected host(s) by storing metadata indicating the assignment(s). At step 516, configuration service 210 transmits instructions to configuration agent 272 to update actual configurations of the selected host(s) to match corresponding desired configurations from the desired state file. After step 516, method 500 ends.

After method 500 ends, upon receiving instructions from configuration service 210, configuration agent 272 applies the desired state file to selected clusters or standalone hosts. Configuration agent 272 transmits the desired state file to one or more VM management appliances that manage the selected clusters or standalone hosts. The VM management appliances then update configurations of the selected clusters or standalone hosts according to the desired state file. For example, for clusters or standalone hosts in SDDC 114-1, configuration agent 272 transmits the desired state file to VM management appliance 260, and VM management appliance 260 updates configurations of services therein accordingly.

Method 500 is performed for each desired state file created. Accordingly, a user creates a plurality of desired state files to apply to different clusters, some clusters being in the same SDDC and others being in different SDDCs. Those desired state files differ from each other, i.e., desired configurations of one desired state file are absent from another. Similarly, a user creates a plurality of desired state files to apply to different standalone hosts, some standalone hosts being in the same SDDC and others being in different SDDCs. As with desired state files for clusters, the desired state files for standalone hosts also differ from each other.

FIG. 6 is a flow diagram of a method 600 performed by configuration service 210 to update and apply a desired state file in response to drift with actual configurations of a cluster or of a standalone host, according to embodiments. For example, method 600 may be triggered by a user selecting via cloud UI 200 to check the compliance of the cluster or standalone host, as discussed above in conjunction with FIG. 4D. At step 602, configuration service 210 receives updated actual configurations of the cluster or standalone host from configuration agent 272. At step 604, configuration service 210 identifies actual configurations of the cluster or standalone host that are in drift with (i.e., that are different from) corresponding configurations of the desired state file assigned thereto.

At step 606, configuration service 210 displays the differences to the user via cloud UI 200. For example, configuration service 210 may display actual configurations and differing desired configurations side-by-side. At step 608, the user specifies via cloud UI 200 whether to update some of the desired configurations of the desired state file. The user may make such changes to the desired state file to match new actual configurations of the cluster or standalone host. If the user selects to update some of the desired configurations of the desired state file, method 600 moves to step 610.

At step 610, configuration service 210 receives changes to some of the desired configurations of the desired state file. At step 612, configuration service 210 updates the desired state file according to the changes from step 610. Returning to step 608, if the user does not select to update any of the desired configurations, method 600 moves directly to step 614. At step 614, configuration service 210 receives a user selection via cloud UI 200 to apply the desired state file to the cluster or standalone host.

At step 616, if the desired state file corresponds to a cluster, method 600 moves to step 618. At step 618, configuration service 210 transmits an instruction to configuration agent 272 to update actual configurations of the cluster to match corresponding desired configurations from the desired state file. After step 618, method 600 ends. Returning to step 616, if the desired state file corresponds to a standalone host, method 600 moves to step 620. At step 620, configuration service 210 transmits an instruction to configuration agent 272 to update actual configurations of the host to match corresponding desired configurations from the desired state file. After 620, method 600 ends. After method 600 ends, upon receiving instructions from configuration service 210, configuration agent 272 applies the desired state file to the cluster or standalone host.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of managing desired states for host computers and for clusters of host computers of software-defined data centers (SDDCs), the method comprising:
creating a first desired state file for a first cluster of the clusters and creating a second desired state file for a second cluster of the clusters, and storing the first and second desired state files together, wherein the first and second clusters are in a first SDDC of the SDDCs, and wherein the second desired state file includes desired configurations that are absent from the first desired state file; and
transmitting a first instruction to update actual configurations of the first cluster to match corresponding desired configurations from the first desired state file and transmitting a second instruction to update actual configurations of the second cluster to match corresponding desired configurations from the second desired state file.

2. The method of claim 1, wherein in response to the instructions to update the actual configurations of the first and second clusters, management software at the first SDDC updates the actual configurations of the first cluster to match the corresponding desired configurations from the first desired state file and updates the actual configurations of the second cluster to match the corresponding desired configurations from the second desired state file.

3. The method of claim 1, wherein the first desired state file is also created for a third cluster of the clusters, the method further comprising:
transmitting a third instruction to update actual configurations of the third cluster to match corresponding desired configurations from the first desired state file.

4. The method of claim 3, wherein the third cluster is in a second SDDC of the SDDCs, and wherein the third instruction is transmitted to management software at the second SDDC.

5. The method of claim 1, further comprising:
creating a third desired state file for a first standalone host computer that is not in any of the clusters and creating a fourth desired state file for a second standalone host computer that is not in any of the clusters, and storing the third and fourth desired state files together, wherein the fourth desired state file includes desired configurations that are absent from the third desired state file; and
transmitting a third instruction to update actual configurations of the first standalone host computer to match corresponding desired configurations from the third desired state file and transmitting a fourth instruction to update actual configurations of the second standalone host computer to match corresponding desired configurations from the fourth desired state file.

6. The method of claim 5, wherein the first and second standalone host computers are in the same SDDC.

7. The method of claim 1, further comprising:
before transmitting the first instruction, displaying at least one difference between the actual configurations of the first cluster and the corresponding desired configurations from the first desired state file.

8. A non-transitory computer-readable medium comprising instructions that are executable in a host computer, wherein the instructions when executed cause the host computer to carry out a method of managing desired states for host computers and for clusters of host computers of software-defined data centers (SDDCs), the method comprising:
creating a first desired state file for a first cluster of the clusters and creating a second desired state file for a second cluster of the clusters, and storing the first and second desired state files together, wherein the first and second clusters are in a first SDDC of the SDDCs, and wherein the second desired state file includes desired configurations that are absent from the first desired state file; and
transmitting a first instruction to update actual configurations of the first cluster to match corresponding desired configurations from the first desired state file and transmitting a second instruction to update actual configurations of the second cluster to match corresponding desired configurations from the second desired state file.

9. The non-transitory computer-readable medium of claim 8, wherein in response to the instructions to update the actual configurations of the first and second clusters, management software at the first SDDC updates the actual configurations of the first cluster to match the corresponding desired configurations from the first desired state file and updates the actual configurations of the second cluster to match the corresponding desired configurations from the second desired state file.

10. The non-transitory computer-readable medium of claim 8, wherein the first desired state file is also created for a third cluster of the clusters, and wherein the method further comprises:
transmitting a third instruction to update actual configurations of the third cluster to match corresponding desired configurations from the first desired state file.

11. The non-transitory computer-readable medium of claim 10, wherein the third cluster is in a second SDDC of the SDDCs, and wherein the third instruction is transmitted to management software at the second SDDC.

12. The non-transitory computer-readable medium of claim 8, wherein the method further comprises:
creating a third desired state file for a first standalone host computer that is not in any of the clusters and creating a fourth desired state file for a second standalone host computer that is not in any of the clusters, and storing the third and fourth desired state files together, wherein the fourth desired state file includes desired configurations that are absent from the third desired state file; and
transmitting a third instruction to update actual configurations of the first standalone host computer to match corresponding desired configurations from the third desired state file and transmitting a fourth instruction to update actual configurations of the second standalone host computer to match corresponding desired configurations from the fourth desired state file.

13. The non-transitory computer-readable medium of claim 12, wherein the first and second standalone host computers are in the same SDDC.

14. The non-transitory computer-readable medium of claim 8, wherein the method further comprises:
before transmitting the first instruction, displaying at least one difference between the actual configurations of the first cluster and the corresponding desired configurations from the first desired state file.

15. A host computer including a configuration service configured to execute on a processor of a hardware platform of the host computer to manage desired states for host computers and for clusters of host computers of software-defined data centers (SDDCs) by performing the following steps:
creating a first desired state file for a first cluster of the clusters and creating a second desired state file for a second cluster of the clusters, and storing the first and second desired state files together, wherein the first and second clusters are in a first SDDC of the SDDCs, and wherein the second desired state file includes desired configurations that are absent from the first desired state file; and
transmitting a first instruction to update actual configurations of the first cluster to match corresponding desired configurations from the first desired state file and transmitting a second instruction to update actual configurations of the second cluster to match corresponding desired configurations from the second desired state file.

16. The host computer of claim 15, wherein in response to the instructions to update the actual configurations of the first and second clusters, management software at the first SDDC updates the actual configurations of the first cluster to match the corresponding desired configurations from the first desired state file and updates the actual configurations of the second cluster to match the corresponding desired configurations from the second desired state file.

17. The host computer of claim 15, wherein the configuration service also creates the first desired state file for a third cluster of the clusters, and wherein the configuration service is further configured to perform the following step:
transmitting a third instruction to update actual configurations of the third cluster to match corresponding desired configurations from the first desired state file.

18. The host computer of claim 17, wherein the third cluster is in a second SDDC of the SDDCs, and wherein the configuration service transmits the third instruction to management software at the second SDDC.

19. The host computer of claim 15, wherein the configuration service is further configured to perform the following steps:
creating a third desired state file for a first standalone host computer that is not in any of the clusters and creating a fourth desired state file for a second standalone host computer that is not in any of the clusters, and storing the third and fourth desired state files together, wherein the fourth desired state file includes desired configurations that are absent from the third desired state file; and
transmitting a third instruction to update actual configurations of the first standalone host computer to match corresponding desired configurations from the third desired state file and transmitting a fourth instruction to update actual configurations of the second standalone host computer to match corresponding desired configurations from the fourth desired state file.

20. The host computer of claim 19, wherein the first and second standalone host computers are in the same SDDC.
